(19) United States
(12) Patent Application Publication
(10) Pub. No.: US 2002/0040303 A1
(43) Pub. Date: Apr. 4, 2002

(54) Storage medium, and digital camera and image handling device using said storage medium

(76) Inventors: Toshihiro Hamamura, Osaka (JP); Masaaki Kuriyama, Kawasaki-shi (JP); Masahito Niikawa, Osaka (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/967,035

(22) Filed: Oct. 1, 2001

(30) Foreign Application Priority Data
Oct. 2, 2000 (JP) 2000-0302689

(51) Int. Cl. G06F 17/60

(52) U.S. Cl. 705/1

(57) ABSTRACT

An image printing system includes a mounting mechanism that mounts a medium on which image data is recorded, an instructing unit by which the user places an order for printing with regard to the images recorded on the medium, a printer that prints the images recorded on the medium, and a controller that inputs the image data recorded on the medium, causes the printer to perform printing in response to the order via the instructing unit, and receives the printing fee, wherein the medium comprises a medium having a prepay function, and the controller updates the prepaid balance in the prepayment information of the medium after the printing instruction is issued from the instructing unit.

This application is based on application No. 2000-302689 filed in Japan, the content of which is hereby incorporated by reference.

1. Field of the Invention

The present invention relates to a self-printing printer that uses a medium on which are recorded images and the like that are captured using a digital camera.

2. Description of the Related Art

With the increasing popularity of digital cameras, printing from media such as memory cards has become more common, replacing conventional printing from sliver halide film. Orders for printing from media on which image data is recorded include, in addition to orders that are placed with conventional photo shops, orders that are placed using the so-called self-printing method, in which a printing order is placed from a vending machine or using a home computer that is connected to a host system.

In the case of printing using the self-printing method, because the user operates the ordering apparatus, improved security and simplified fee settlement are required. In order to simplify fee settlement, Japanese Laid-Open Patent Application Hei 10-302045 discloses a combination of an image storage medium (image medium) and a prepaid card. However, the disclosure does not include description of a specific construction or system, and such practical issues as ease of operation and prevention of misuse still remain.

### SUMMARY OF THE INVENTION

An object of the present invention is to simplify fee settlement in the self-printing method in which a memory card having a prepay function is used.

The image printing system pertaining to the present invention includes a mounting mechanism that mounts a medium on which image data is recorded, an instructing unit by which the user places an order for printing with regard to the images recorded on the medium, a printer that prints the images recorded on the medium, and a controller that inputs the image data recorded on the medium, causes the printer to perform printing in response to the order via the instructing unit, and receives the printing fee. Here, the medium mentioned above comprises a medium having a prepay function, and the controller updates the prepaid balance in the prepayment information of the medium after the printing instruction is issued from the instructing unit.

In the image printing system, the controller accepts a printing instruction after the image data is read from the medium.

The medium comprises a medium using which data recording and reading may be performed by a computer and which has a prepay function. The storage area thereof comprises a first area, in which money management information including the prepaid balance is recorded, and a second area, in which image data is recorded.

In the above medium, the first area is configured such that writing via the device by which the user records images is disabled.

In the above medium, the money management information in the first area is encoded and recorded.

The digital camera pertaining to the present invention includes an optical device that captures images of the object, a mounting mechanism that mounts a medium on which the captured image data is recorded and that has a prepay function, an operating means by which the user instructs the start of an image capture operation via the optical device, and a controller that records the data regarding the image captured by the optical device on the medium having a prepay function based on the operation via the operating means.

In the above digital camera, the controller records the image data in the storage medium without affecting the information regarding the prepay function.

In the above digital camera, wherein the medium is a medium using which data writing and reading by the controller is enabled, and wherein the recording area thereof comprises a first area in which money management information including the prepaid balance is recorded and a second area in which image data is recorded, the controller records the image data in the second area of the medium.

The above digital camera includes a display in which data is displayed, and the controller accesses the medium to display on the display the information regarding the prepay function.

In the digital camera, the medium is configured such that rewriting of the information regarding the prepay function is disabled.

The image handling device pertaining to the present invention includes a mounting mechanism that mounts a medium on which image data is recorded and which has a prepay function, an instructing means by which the user places an order for printing regarding the images recorded on the medium, a printer that prints the data, and a controller that updates the prepaid balance in the storage medium and causes the printer to print a receipt for the printing order, which includes the prepaid balance, in response to the printing order issued via the instructing means.

The image handling device pertaining to the present invention includes a mounting mechanism that mounts a storage medium on which image data is recorded and which has a prepay function, and that includes a removal preventing means that prevents the removal of the mounted storage medium, an instructing means by which the user places an order for printing regarding the images recorded on the storage medium, and a control means that inputs the image data recorded on the storage medium, calculates the fee for the printing ordered via the instructing means and updates the prepaid balance. Here, the control means prevents the removal of the storage medium by operating the removal preventing means of the mounting mechanism until the updating of the prepaid balance is completed.

The image handling device pertaining to the present invention includes a mounting mechanism that mounts a storage medium on which image data is recorded and that has a prepay function, an instructing means by which the user places an order for printing regarding the images recorded on the storage medium, and a control means that inputs the image data recorded on the storage medium, calculates the fee for the printing ordered via the instructing means and updates the prepaid balance. Here, the control means nullifies the printing order if the storage medium is removed from the mounting mechanism before the prepaid balance is updated.

The image handling device pertaining to the present invention includes a mounting mechanism that mounts a storage medium on which image data is recorded and that has a prepay function, an instructing means by which the user places an order for printing regarding the images recorded on the storage medium, a money receiving means that receives money, and a control means that inputs the image data recorded on the storage medium, processes the receipt of money via the money receiving means, calculates the fee for the printing ordered via the instructing means and updates the prepaid balance. Here, the control means settles the printing fee by combining together the prepaid balance in the storage medium and the cash added using the money receiving means.

The image handling device pertaining to the present invention includes a mounting mechanism that mounts a storage medium on which image data is recorded and that has a prepay function, an instructing means by which the user places an order for printing regarding the images recorded on the storage medium, a money receiving means that receives money, and a control means that inputs the image data recorded on the storage medium, processes the receipt of money via the money receiving means, calculates the fee for the printing ordered via the instructing means and updates the prepaid balance. Here, the control means updates the prepaid balance of the storage medium by combining together the prepaid balance in the storage medium and the cash added using the money receiving means.

The image handling device pertaining to the present invention includes a mounting mechanism that mounts a storage medium on which image data is recorded and that has a prepay function, an instructing means by which the user places an order for printing regarding the images recorded on the storage medium, and a control means that inputs the image data recorded on the storage medium, calculates the fee for the printing ordered via the instructing means and updates the prepaid balance. Here, the control means accesses the prepayment information in the storage medium and outputs the information using a display means or a printing means.

The image handling device pertaining to the present invention includes a mounting mechanism that mounts a storage medium on which image data is recorded and that has a prepay function, an instructing means by which the user places an order for printing regarding the images recorded on the storage medium, and a control means that inputs the image data recorded on the storage medium, calculates the fee for the printing ordered via the instructing means and updates the prepaid balance. Here the control means calculates the printing fee in accordance with the printing history.

In accordance with the printing fee recording method pertaining to the present invention, in an image output system comprising a mounting mechanism that mounts a storage medium on which image data is recorded and that has a prepay function, an instructing means by which the user places an order for printing regarding the images recorded on the storage medium, and a printing means that prints the images recorded on the storage medium, when the image data is input from the storage medium and the user orders printing of the images recorded on the storage medium, the printing history is recorded on the storage medium, a fee for the ordered printing is calculated based on the printing history, and the prepaid balance recorded on the storage medium is updated accordingly.

The computer-readable storage medium pertaining to the present invention stores a program comprising a step for inputting image data from the storage medium in which the image data is recorded and which has a prepay function, a step for receiving a printing order from the user for the images recorded on the storage medium, a step for causing the printing means to print the images in accordance with the printing order, and a step for updating the prepaid balance in the prepayment information in the storage medium after the printing order is executed.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 is a perspective view of a vending machine-type image output device.

FIG. 2 is a cross-sectional view of the medium insertion inlet.

FIG. 3 is a drawing showing the logical construction of the memory card.

FIG. 4 is a block diagram of the control system of the image output device.

FIG. 5 is a flow chart showing the control of a vending machine-type image output device.

FIG. 6 is a flow chart regarding the screen display.

FIG. 7A through FIG. 7K are drawings showing the displayed screen.

FIG. 8A through FIG. 8C are drawings showing examples of receipts.

FIG. 9 is a front elevation of a digital camera.

FIG. 10 is a rear elevation of a digital camera.

FIG. 11 is a block diagram of the control system of a digital camera.

FIG. 12 is a flow chart of the control sequence followed regarding a digital camera during image capture.

FIG. 13 is a flow chart of the control sequence followed regarding a digital camera when the prepaid card information is referenced.

FIG. 14 is a drawing showing an example of card display.

FIG. 15 is a drawing showing the situation in which the print center is connected via a network.

FIG. 16 is a drawing showing a dedicated input terminal.

FIG. 17 is a drawing showing a computer.

FIG. 18 is a flow chart of a printing order from a computer.

### DESCRIPTION OF THE PREFERRED EMBODIMENTS

The embodiments of the present invention are explained below with reference to the accompanying drawings. In the drawings, identical numbers indicate identical or equivalent members.

In the embodiments explained below, a self-printing system that uses a memory card having a prepay function will be explained. The memory card comprises a smart medium, memory stick or SD card. When using a vending machine-type image output device, the user orders printing using a memory card having a prepay function, and receives the prints then and there. In a system using the Internet, the user orders printing via a dedicated terminal or computer using a memory card having a prepay function, and the print center creates prints in accordance with the printing order and delivers them through home delivery service or a similar method.

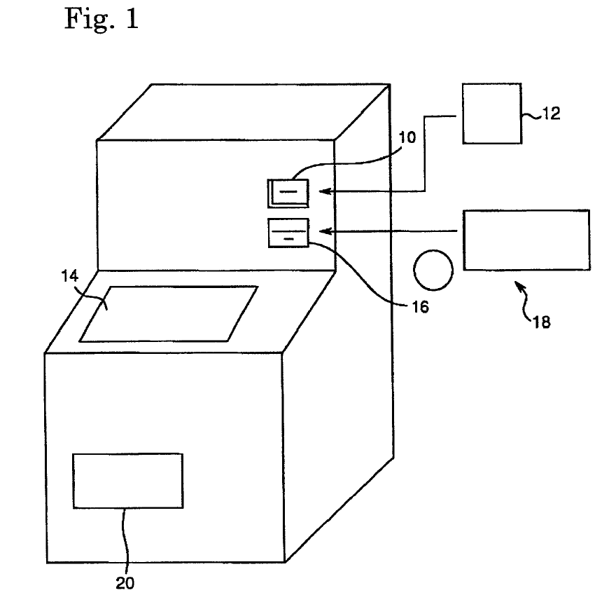

FIG. 1 shows the external view of the vending machine-type image output device pertaining to a first embodiment. When the user inserts a memory card (medium) 12 into the memory card reader 10 on the front panel of the image output device, an ordering screen is displayed on the operation panel 14. The user checks the thumbnail images on the operation panel 14, and specifies the print size as well as the number of prints. The user also can insert the printing fee (bills or coins) 18 via the vending unit (coin identification machine/bill identification machine) 16. Consequently, printing of the images is begun in accordance with the details of the printing order. The user receives the created prints via the receiving outlet 20. This image output device includes a sliver halide printing system, and creates prints by performing exposure and development on printing paper in accordance with the image data, but the details thereof will be omitted from this explanation. The image output device may comprise an inkjet printer or heat transfer printer using the thermal transfer method or the dye-sublimation method. For the memory card 12, in addition to a regular memory card, a card that also functions as a prepaid card may also be used. When the prepaid card is inserted or when cash is inserted, execution of the printing order begins.

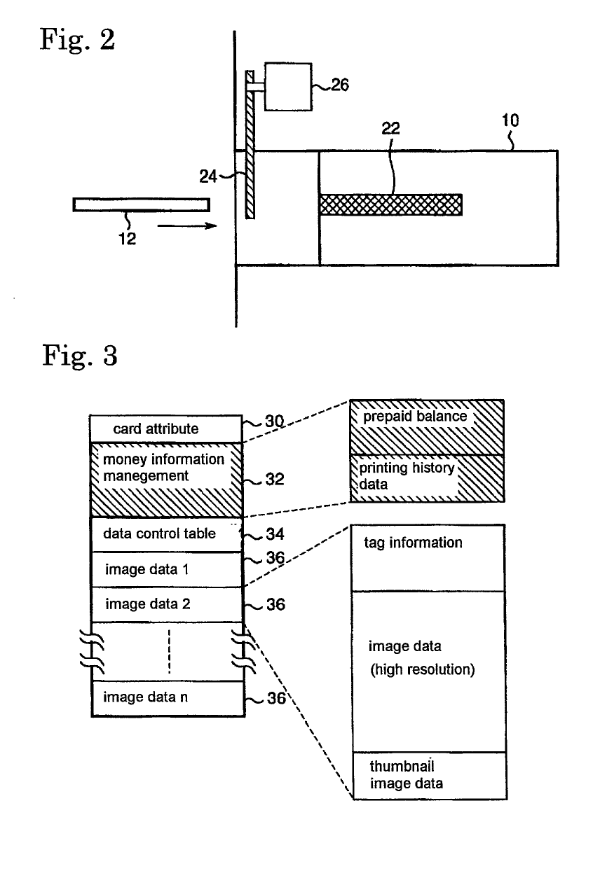

FIG. 2 shows a cross-sectional view of the memory card reader 10. A memory card slot 22 is located at a position at which the memory card 12 may be inserted. When a memory card 12 is inserted, the transparent shutter 24 is moved upward. A drive motor 26 moves the shutter 24 up and down in order to open and close it. As a memory card 12 is inserted, the shutter 24 is closed to lock the memory card 12 such that it cannot be removed.

This image output device accepts as the memory card 12 a memory card that has a prepay function or a memory card that does not have a prepay function. FIG. 3 shows the logical construction of a memory card having a prepay function. This memory card comprises a first area in which the administrative information such as the prepaid balance is recorded, and a second area in which image data is recorded. The two areas are allocated to separate partitions. Consequently, management of the prepayment information may be made easier, and the situation in which the prepayment information is destroyed by mistake may be prevented. The first area comprises a card attribute area 30, which is configured to be invisible and which is used in the determination of the prepaid card attribute, and a money information management area 32, which is configured to be invisible, while the second area comprises an invisibly configured data control table 34 and n number of visibly configured image areas 36. The money information management area 32 further comprises a prepaid balance area and a printing history data area that indicates the history of printing using the card. The data management table 34 is a table that manages the multiple image areas 36, and each image area 36 comprises a tag information area, an image data area and a thumbnail image area. Here, because the first area is configured such that writing by the user is disabled, a situation in which the user deletes the prepayment information by mistake is prevented. In addition, because the administrative information is recorded in a coded format in the money information management area 32, misuse of the prepayment information, etc. may be prevented. The information in the money information management area may be made updateable via hardware.

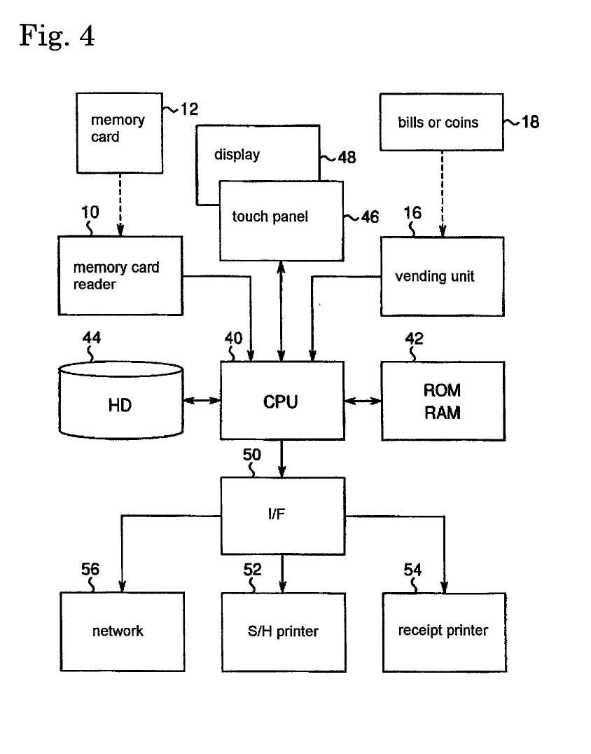

FIG. 4 shows the construction of the control system of the image output device. The control system comprises a CPU 40, which is the main component, as well as other members, and the CPU 40 is connected to the memory 42 and the hard disk device 44. The CPU 40 accesses the data in the memory card 12 inserted in the memory card reader 10. The CPU 40 receives the input by the user via the touch panel 46 of the operation panel 14, and displays images and various messages in the display unit 48 of the operation panel 14. The CPU 40 also controls the vending unit 16 and receives the fee. The CPU 40 controls the silver halide printer 52 via the interface 50 in accordance with the details of the order, and prints a receipt using the receipt printer 54. The CPU 40 is further connected to the network 56 via the interface 50.

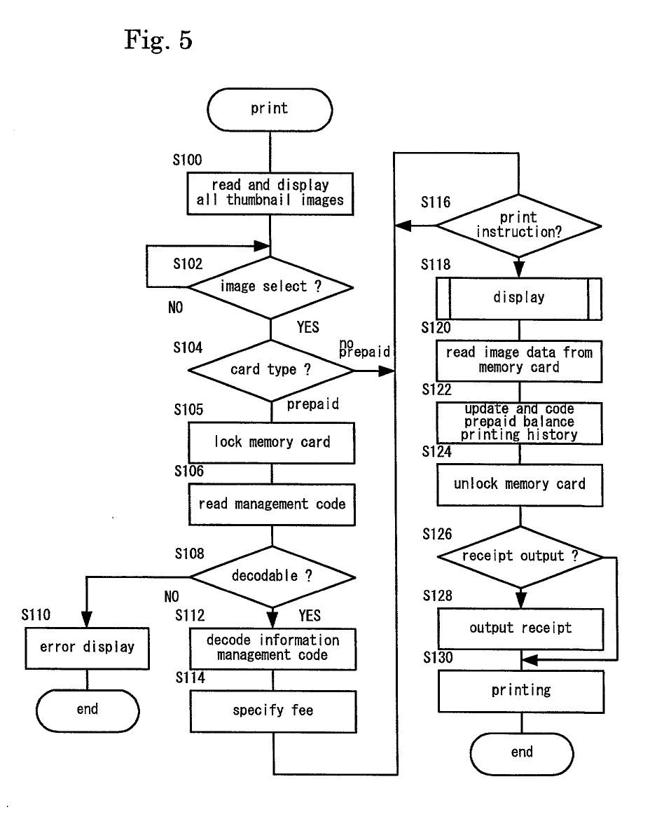

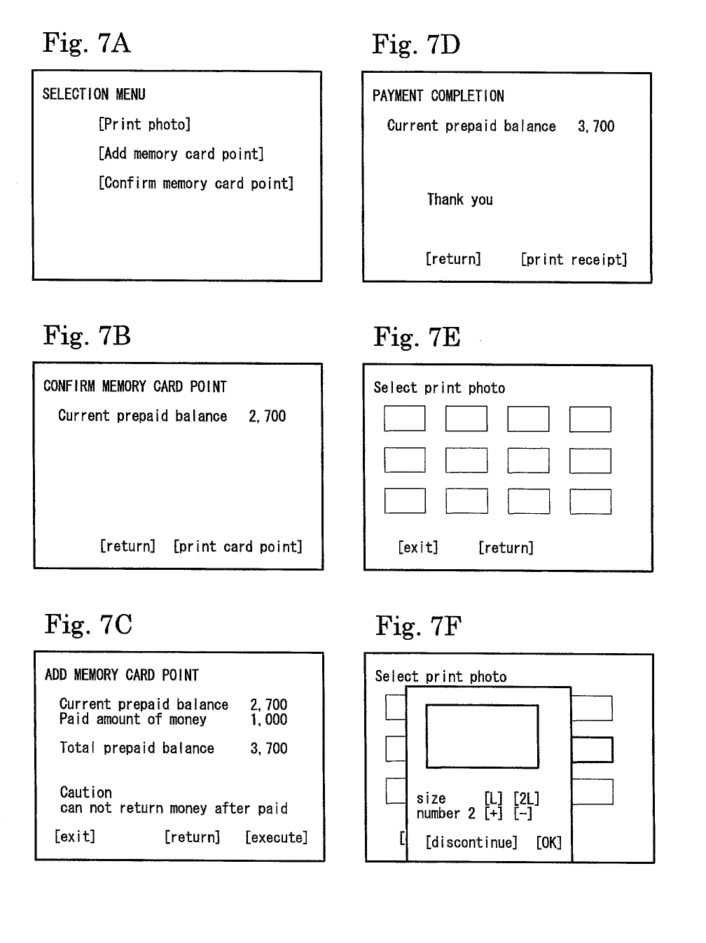

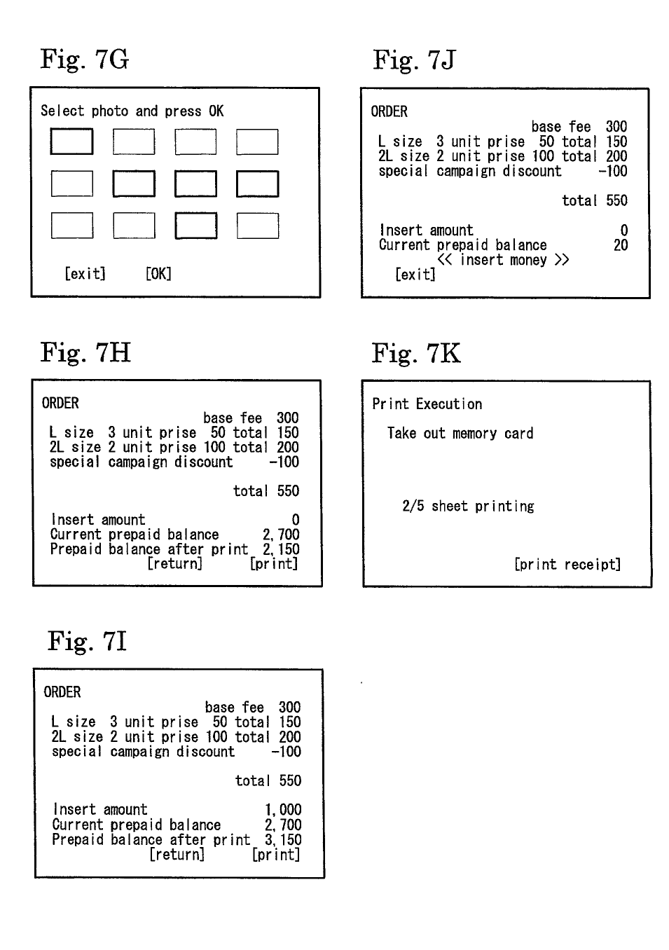

FIG. 5 shows the print control sequence carried out by the control system of the image output device. First, the thumbnail images for all of the image data are read from the memory card 12 and displayed on the display unit 48 (S100). When the user performs an image selection operation (S102), the memory card attribute (which indicates whether or not the card is a prepaid card) is read from the card attribute area 30 of the memory card 12 to determine the type of memory card (S104). Where the memory card is not a prepaid card, the CPU 40 advances to step S116. On the other hand, where the memory card is a prepaid card, the shutter 24 is closed in order to lock the memory card (S105). The code in the money information management area 32 in the memory card 12 is then decoded (S106). If the code is not decodable (NO in S108), an error display is performed (S110), and the process comes to an end. On the other hand, where the code is decodable (YES in S108), the prepaid balance file and the printing history file in the money information management area 32 are read (S112), the screen for specifying the fee and ordering is displayed on the display unit 48, the user's order is accepted, and the receipt of money is processed (S114). Here, the user's order is established.

Where the user issues a printing instruction (YES in S116), the screen display is updated to the printing underway screen (see FIG. 7K) (S118), the image data to be printed is read from the memory card 12 (S120) in accordance with the details of the order, and the prepaid balance and printing history in the money information management area 32 are updated (S122). The prepaid balance of the prepaid card 12 is updated in this way after a printing instruction is issued. Where there is no printing instruction, on the other hand, the balance of the prepaid card is not updated, so there is no complaint by the user complaint.

The shutter 24 is then opened in order to unlock the memory card 12 (S124). If the memory card could be removed at any moment, there is a possibility that printing could be performed without updating of the prepaid balance (i.e., with the original prepaid balance left intact) if the card were removed before the prepayment information were updated. In this embodiment, because the removal of the memory card is disabled until the updating of the prepayment information is completed, misuse and data tampering can be prevented.

Where output of a receipt is instructed (YES in S126), a receipt is output by the receipt printer 54 (S128). The receipt includes a printed balance for the prepaid card. In general, where an image data storage medium has a prepaid card function, the prepaid balance cannot be displayed, but because a receipt can be output when the image input is carried out, the user can easily see the prepaid balance. The silver halide printer 52 then executes printing in accordance with the details of the order (S130).

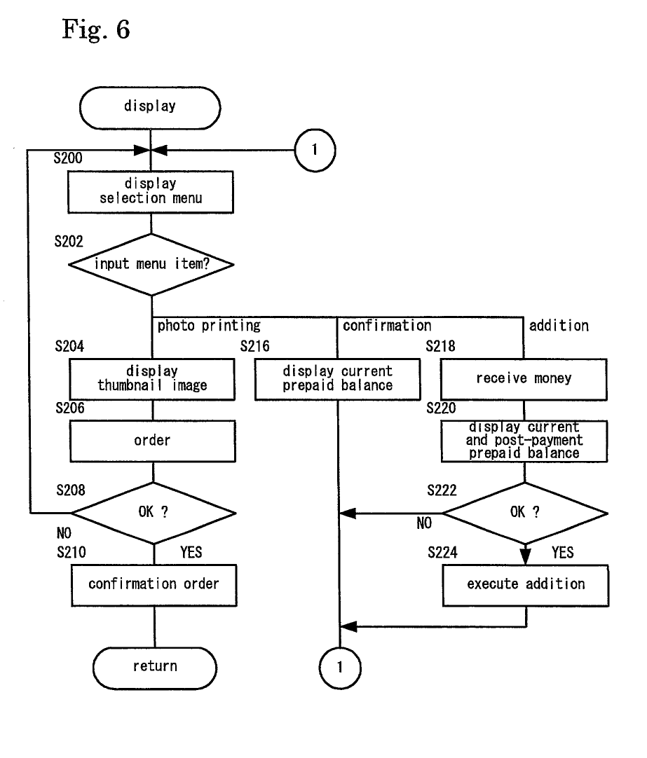

FIG. 6 shows an example of the screen display for the fee setting process (S118 in FIG. 5). When a memory card is inserted or cash is inserted in addition to the insertion of a memory card, a selection menu is displayed on the display unit 48 (S200). The selection menu comprises three items, i.e., photo printing, addition of memory card points, and confirmation of memory card points. If the photo printing menu item is selected (S202), the thumbnail images for the images in the memory card are displayed (S204), and the user's order is accepted (S206). Where the user instructs discontinuation of the order (NO in S208), the inserted money is returned, the shutter 24 is opened to expose the memory card, and the CPU 40 returns to step S200. If the user approves the order (YES in S208), the details of the order are displayed for confirmation (S210). The details of the order, the fee therefor, the inserted money amount, and the current and post-printing prepaid balances are displayed on this embodiment. The fee setting process comes to an end at this point, and the CPU 40 returns to the printing process (FIG. 5).

Where the menu item to confirm the memory card points is selected from the selection menu (S202), the current prepaid balance is displayed (S216). The CPU 40 then returns to step S200.

Where the menu item to add memory card points is selected from the selection menu (S202), the inserted money 18 is received via the vending unit 16 (S218), and the current and post-payment prepaid balances are displayed (S220). Where the user discontinues the adding of points, the CPU 40 returns to step S200. Where the user instructs ‘OK’ after confirming the inserted money amount (YES in S222), addition of points is executed, a receipt is issued via the receipt printer 54 (S224), and the CPU 40 returns to step S200. Through this point adding process, prepaid card points may be added. In other words, even if the card has a small prepaid balance left, the prepaid balance can be increased by adding more cash. Therefore, the printing fee can be settled based on the sum of the prepaid balance and the added cash. In addition, because the prepaid balance is rewritten based on the received amount of money, the memory card 12 can be reused as a prepaid card.

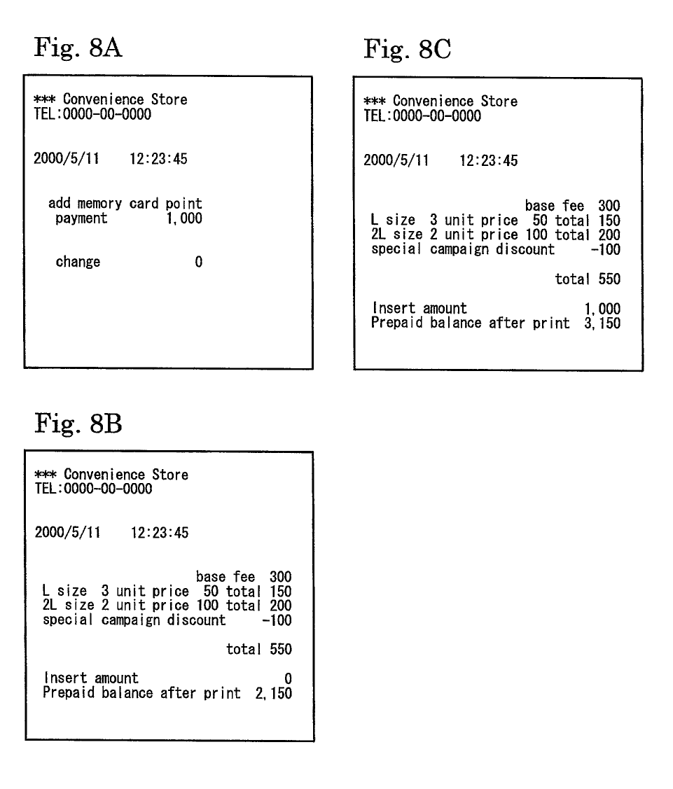

FIG. 7A through FIG. 7K are drawings showing the display screen in the display unit 48 that correspond to each stage of the above process, and FIG. 8A through FIG. 8C are examples of receipt output that occur as the process advances. When a memory card 12 is inserted, the shutter 24 closes. The selection menu (FIG. 7A) is then displayed on the screen.

Here, if ‘Confirm memory card points’ is pressed in this screen, the current prepaid balance is displayed on the memory card point confirmation screen (FIG. 7B).

When ‘Add memory card points’ is pressed in the selection menu screen and money is inserted, the current prepaid balance, the paid amount of money, and the prepaid balance after payment are displayed on the memory card money insertion screen (FIG. 7C). If ‘Execute’ is pressed in this screen, the post-payment prepaid balance is displayed on the payment completion screen (FIG. 7D), and the receipt shown in FIG. 8C is output. The receipt includes the paid amount.

Where ‘Print photo’ is pressed in the selection menu screen, the thumbnail images for the images recorded on the memory card are displayed on the photo selection screen (FIG. 7E). In this example, the thumbnail images are aligned in three lines and four rows. If ‘Discontinue’ is pressed at this point, the inserted money 18 is returned, and the shutter 24 opens. If any of the thumbnail images is pressed, an indication that that thumbnail image is selected is made, and the ordering screen (FIG. 7F) for that image is displayed. The print size and number of prints are selected using this screen. When ‘OK’ is pressed here, the print instruction screen (FIG. 7G) is displayed. On this screen, five image prints are ordered as an example. If a thumbnail image is pressed at this point, the previous screen (FIG. 7F) is displayed again. If ‘Discontinue’ is pressed, the inserted money is returned and the shutter 24 opens.

When ‘OK’ is pressed in the printing instruction screen (FIG. 7G), the details of the order are displayed. Where a memory card 12 is inserted and no cash is inserted, the printing details, the fee for printing, and the current and post-printing prepaid balance are displayed (FIG. 7H). Where a memory card 12 is inserted and cash is inserted, a similar order screen is displayed, and the inserted amount of money is also displayed (FIG. 7I). In these examples, a special campaign fee discount is also displayed. Where the balance is short of the fee, on the other hand, the message ‘Printing is not available. Insert cash.’ is displayed on the screen (FIG. 7J) together with the details of the ordered printing. If cash is inserted here, the screen shown in FIG. 7I is displayed. If ‘Discontinue’ is pressed, on the other hand, the inserted money is returned, and the shutter 24 opens. Where ‘Print’ is pressed in the screen shown in

FIG. 7H or FIG. 7I, the printing order is confirmed, printing is begun and the shutter 24 opens. The printing underway screen (FIG. 7K) is displayed, and the message ‘Remove memory card’ is displayed. If ‘Output receipt’ is pressed here, the receipt shown in FIG. 8B or FIG. 8C is output. On the receipt is printed the information regarding the details of the order, the inserted amount of money, the post-printing prepaid balance and the discount.

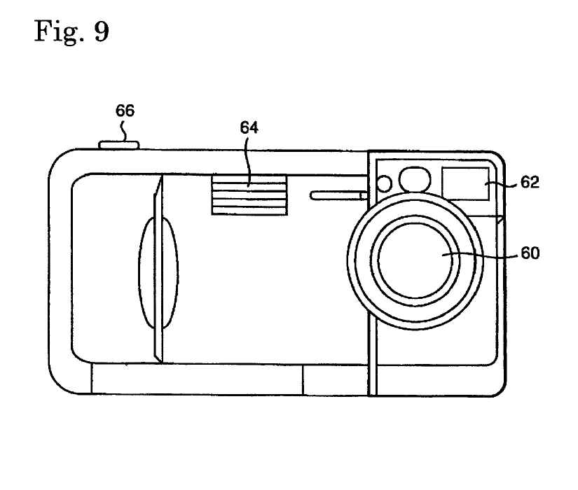

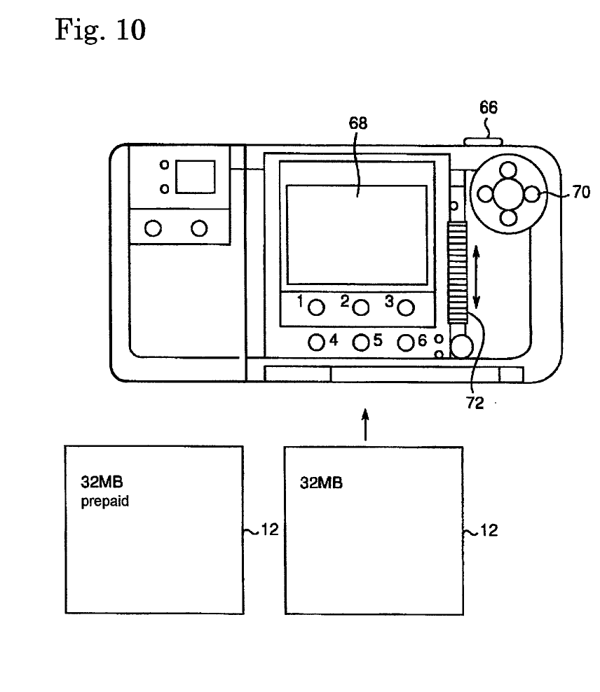

FIGS. 9 and 10 show a digital camera in which is used a memory card that has a prepay function. This digital camera is identical to a normal digital camera except that it accepts a memory card having a prepay function. On the front side of the camera are located a lens 60, a finder 62, a flash 64, a shutter release button 66, etc. On the rear side of the camera are located a liquid crystal display 68 having a backlight, direction buttons 70 and a power switch 72. This digital camera accepts a memory card (a storage medium) 12 that also works as a prepaid card regarding the printing fee. The memory card 12 is inserted from the bottom of the digital camera. The image captured via the lens 60 is detected by a CCD sensor, which is not shown in the drawings, and is recorded on the memory card 12.

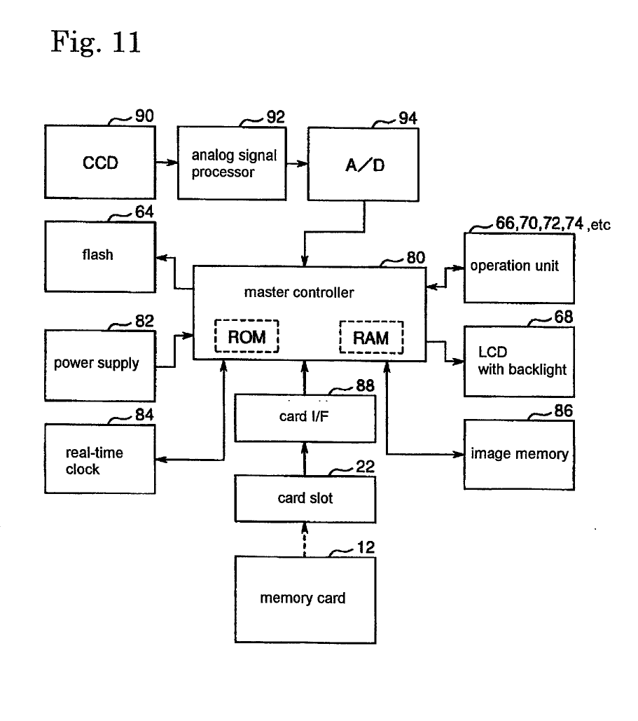

FIG. 11 is a block diagram of the control system of the digital camera. The digital camera is controlled by a master controller 80 comprising a CPU that includes a ROM and a RAM. The master controller 80 is driven by a power supply 82, and receives clock signals from the real-time clock 84. The master controller 80 is also connected to the various operation units (66, etc.), the liquid crystal display 68 having a backlight and the image memory 86. The master controller 80 accesses the memory card 12, which is inserted in the memory card slot 22, via the card interface 88. The master controller 80 also drives the flash 64. The image signal detected by the CCD sensor 90 is processed by the analog signal processor 92 and then converted into a digital value by the A/D converter 94. It is then sent to the master controller 80.

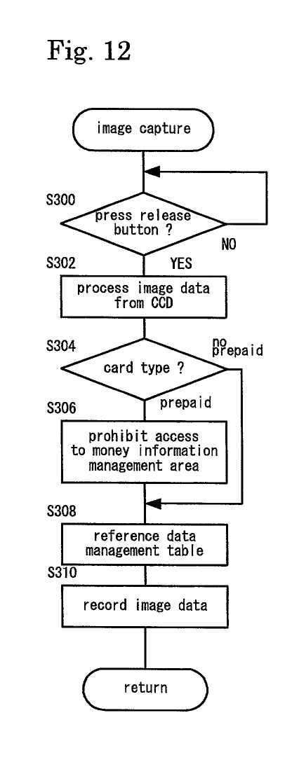

FIG. 12 shows the control sequence performed during image capture using the digital camera. When the shutter release button 66 is pressed (S300), image data is received from the CCD sensor 90 and processed (S302). The memory card attribute is then determined (S304), and where the memory card is determined to have a prepaid card attribute, access to the money information management area 122 of the memory card is prohibited (S306). The data management table 34 is then referenced (S308), and the captured image data is recorded in an empty image data area 36 of the data recording area (S310).

Memory cards (storage media) 12 that also operate as prepaid cards for the printing fee may also be used in this digital camera. During image capture by the digital camera, image capture and recording may be performed without affecting the administrative information such as the prepaid balance, etc. in the memory card 12. Because it is not necessary to know during image capture whether the card is a regular card or a card with a prepay function, ease of use is improved.

The memory card 12 comprises a first area, in which administrative information such as the prepaid balance is recorded, and a second area, in which image data is recorded, as shown in FIG. 3, and images are recorded in the second area. Therefore, the situation in which the prepayment information is destroyed by mistake during image capture can be prevented.

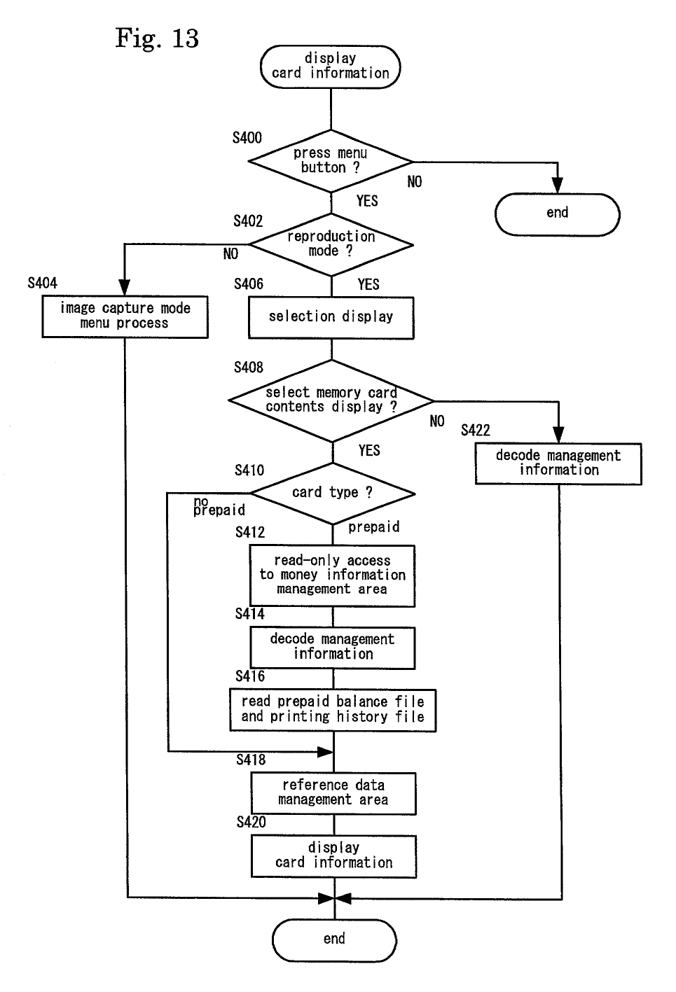

FIG. 13 shows the control sequence performed when the digital camera references the prepaid card information. When the menu button 70 is pressed (S400), if the mode is not the reproduction mode (NO in S402), image capture mode menu processing (involving such parameters as the shutter speed) is carried out (S404). On the other hand, if the mode is the reproduction mode (YES in S402), selection display is performed (S406). When memory card contents display is selected from the menu (YES in S408), and where the memory card attribute is a prepaid card attribute (YES in S410), the money information management area 32 of the memory card 12 is accessed via read-only access (S412), the code of the money management information is decoded (S414), and the prepaid balance file and printing history file in the money information management area 32 are read (S416). The data management table 34 is then referenced (S418), and the image information in the card is displayed (S420). Where another menu item is selected from the menu (NO in S408), appropriate processing is performed (S422), but these processes will not be explained in detail herein.

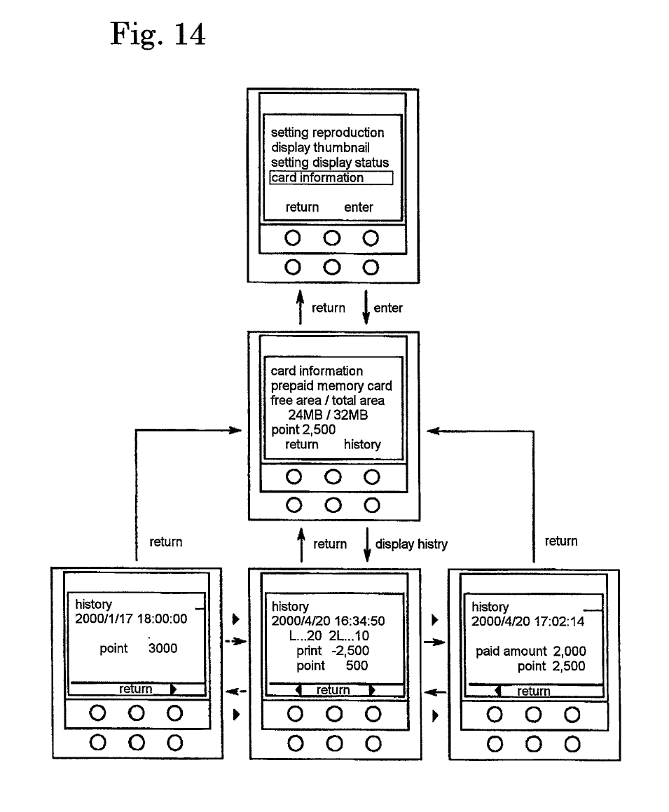

In the display of the card information (S420), the usable capacity and total capacity of the prepaid memory card (24MB and 32MB, for example) as well as the prepaid balance, are displayed. FIG. 14 shows one example of the card display. When execution of viewing of the card information is instructed via the top screen shown in FIG. 14, the middle screen in FIG. 14 is displayed. If history display is selected in that screen and the left or right direction button is pressed, the use history is displayed in sequence from the history table of the printing history file, as shown in the bottom row of FIG. 14. In these screens, the history regarding the dates and time of image capture, as well as the remaining points and the history regarding the dates and times of money insertion and the remaining points, are displayed. The user can view the card information and the printing history information while using the digital camera by pressing the menu button in this way.

When a memory card that also works as a prepaid card for the printing fee as described above is used in the digital camera, the user can view the prepayment information and easily check the prepayment information regarding the prepaid card during image capture. In addition, because this prepayment information may be viewed but cannot be rewritten, misuse thereof may be prevented.

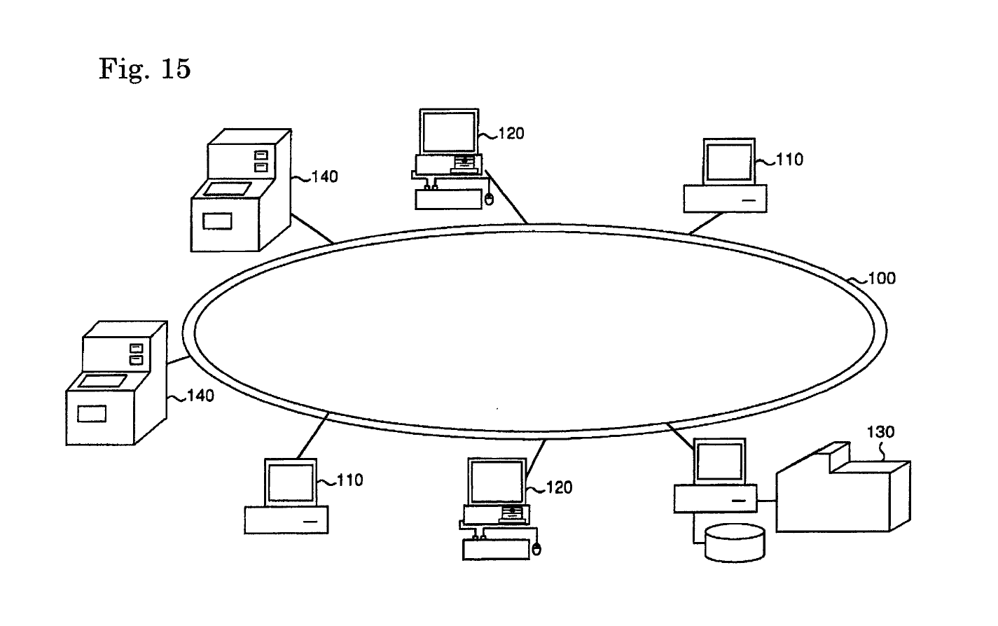

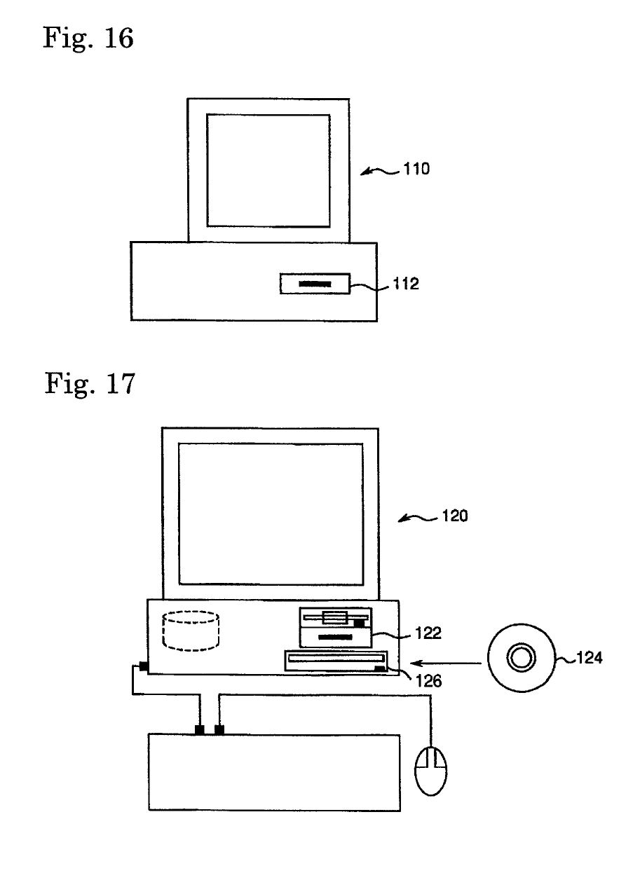

In the embodiment explained below, printing is ordered from the print center via the Internet using a dedicated input terminal or computer. FIG. 15 shows the situation in which multiple dedicated input terminals 110 and computers 120 are connected to the printing system 130 at the print center via a network (such as the Internet) 100. Vending machine-type image output devices 140 are also connected thereto. The printing system 130 at the print center comprises a Web server and a printing device. When a printing order is received from a dedicated input terminal 110 or computer 120, the printing system 130 at the print center performs printing in accordance with the order, and the resulting prints are delivered to the user via home delivery service. The dedicated input terminal 110 includes a memory card drive 112 in which a prepaid memory card 12 is inserted, as shown in FIG. 16. The construction of the control system thereof is identical to that shown in FIG. 4, except that the printing portion is not present. The computer 120 similarly includes, as shown in FIG. 17, a memory card drive 122 in which a prepaid memory card 12 is inserted. The computer 120 reads a software program to create printing orders from a CD-ROM 124 via the CD-ROM drive 126, and installs the program on its hard disk HD. By using this software program, the computer can place printing orders with the printing system 130 at the print center. According to this software program, after printing of image data is instructed using a memory card, which also works as a prepaid card for the printing fee, the prepayment information regarding the prepaid card (the balance) is updated. It then sends the printing instruction data and image data to the print center. Through this process, settlement for a printing order placed from home may be accomplished easily. Furthermore, the software program may be supplied not only from a CD-ROM but also from a specific server.

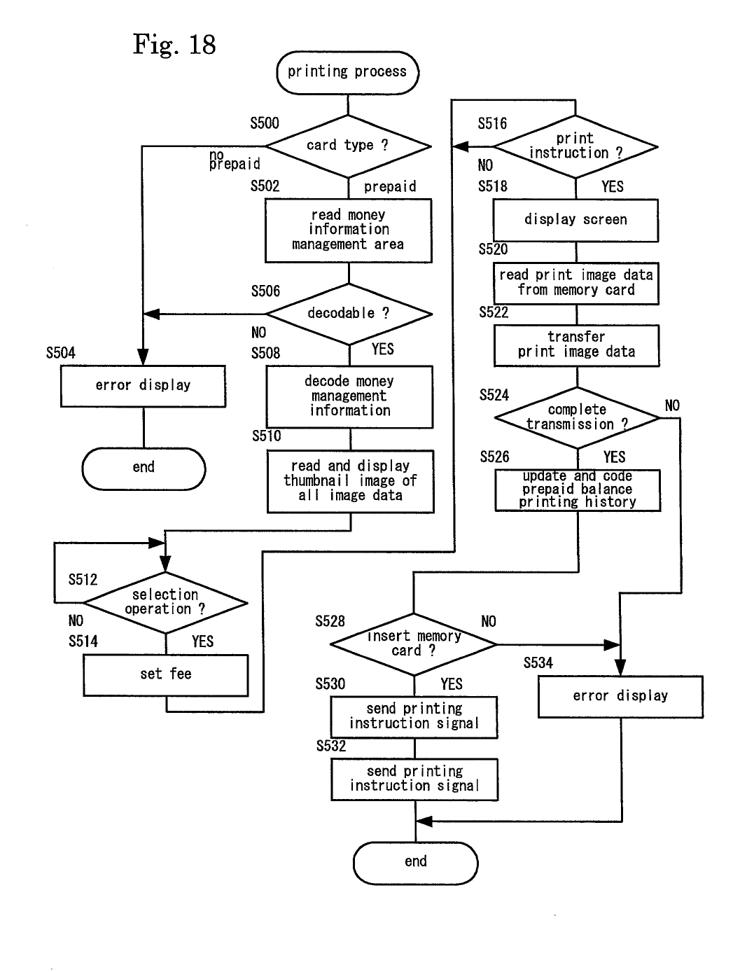

FIG. 18 shows the sequence of a printing order placed from a computer 120. The memory card determination attribute is first read from the memory card 12 (S500), and where the attribute is not a prepaid card attribute (NO in S500), an error display is performed (S504), whereupon the process comes to an end. Where the attribute is a prepaid card attribute (YES in S500), on the other hand, the code of the money management information of the card is decoded (S502). If the code can be decoded (YES in S506), the prepaid balance file and printing history file are read (S508). The prepayment information and printing history are displayed here. The thumbnail images for all image data are then read and displayed (S510). The fee is then set (S514) in accordance with the image selection operation performed by the user (S512).

When the fee is set, the printing history may be taken into consideration. If the printing history indicates three or more printing orders in the past, ¥100 is subtracted from the regular fee as the printing fee, for example. Setting the printing fee in accordance with the printing history in this way when a prepaid card is used enables a discount to be offered in accordance with the amount of use by the user.

When the user instructs that printing be performed (YES in S516), the screen that indicates that the data is being transmitted is displayed (S518). The image data to be printed is then read from the memory card 12 (S520), and is then sent (S522). If the transmission is completed normally (YES in S524), the prepaid balance and printing history, which are the administrative information regarding the card, are updated and encoded (S526). If a memory card is inserted (YES in S528), a printing instruction signal is sent (S530), and a display is performed indicating that removal of the memory card is permitted (S532). Where the transmission does not end normally (NO in S524) or where a memory card is not inserted, an error display is performed (S534). Because a signal that instructs actual printing is not sent until the prepaid balance and printing history data in the money information management area 32 of the memory card are updated in this way, even if the memory card is removed immediately after the completion of data transmission, the card cannot be wrongly used and the data thereon cannot be tampered with.

In the image output device, when printing is not instructed, the prepayment information on the memory card is not updated, and therefore user complaints do not result.

The prepayment information in the memory card can be easily managed separately from the image information. In addition, by separating the recording area into a first area in which administrative information, such as the prepaid balance, is recorded, and a second area in which image data is recorded, the prepayment information is not deleted by mistake. Further, by encoding the money management information, misuse of and tampering with the prepayment information may be prevented.

Because a regular memory card or card having a prepay function can be used in the digital camera, the digital camera can be used during image capture without paying attention to whether the card is a regular memory card or a card with a prepay function, and therefore the ease of use increases.

The prepayment information may be easily checked during image capture or during the issuance of a printing order using a prepaid card.

If the card has a small prepaid balance, it can be used when combined with inserted cash, which also enables reuse of the memory card.

Settlement of the printing fee may be easily performed at home.

Although preferred embodiments of the invention have been described in the foregoing detailed description and illustrated in the accompanying drawings, it will be understood that the invention is not limited to the embodiments disclosed, but is capable of numerous rearrangements, modifications and substitutions of parts and elements without departing from the spirit of the invention. Accordingly, the present invention is intended to encompass such rearrangements, modification and substitutions of parts and elements as fall within the spirit and scope of the invention.

What is claimed is:

1. An image printing system comprising:
a mounting mechanism that mounts a medium having a prepay function on which image data is recorded;
an instructing unit by which the user places an order for printing with regard to the images recorded on the medium;
a printer that prints the images recorded on the medium; and
a controller that reads the image data recorded on the medium, causes the printer to perform printing in response to the order via the instructing unit, receives the printing fee, and updates the prepaid balance in the prepayment information of the medium after the printing instruction is issued from the instructing unit.

2. An image printing system according to claim 1, wherein said controller accepts a printing instruction after the image data is read from the medium.

3. A medium using which data recording and reading may be performed by a computer and which has a prepay function, wherein said medium comprising:
a first data storage area which stores money management information including the prepaid balance; and
a second data storage area which stores image data.

4. A medium according to claim 3, wherein said first data storage area is configured such that writing via the device by which the user records images is disabled.

5. A medium according to claim 3, wherein said first data storage area records the encoded money management information.

6. A digital camera comprising:
an optical device that captures images of the object;
a mounting mechanism that mounts a medium having a prepay function;
an operating means by which the user instructs the start of an image capture operation via the optical device; and
a controller that records the data regarding the image captured by the optical device on the medium based on the operation via the operating means.

7. A digital camera according to claim 6, wherein said controller records the data in the medium without affecting the information regarding the prepay function.

8. A digital camera according to claim 6, wherein the medium comprises a first area in which money management information including the prepaid balance is recorded and a second area in which image data is recorded, and said controller records the image data in the second area of the medium.

9. A digital camera according to claim 6, further comprising a display in which data is displayed, and the controller accesses the medium to display on the display the information regarding the prepay function.

10. An image handling device comprising:
a mounting mechanism that mounts a medium on which image data is recorded and which has a prepay function;
an instructing means by which the user places an order for printing regarding the images recorded on the medium;
a printer that prints the data; and
a controller that updates the prepaid balance in the storage medium and causes the printer to print a receipt for the printing order, which includes the prepaid balance, in response to the printing order issued via the instructing means.

11. An image handling device comprising:
a mounting mechanism that mounts a storage medium on which image data is recorded and which has a prepay function, and that includes a removal preventing means that prevents the removal of the mounted storage medium;
an instructing means by which the user places an order for printing regarding the images recorded on the storage medium; and
a controller that reads the image data recorded on the storage medium, calculates the fee for the printing ordered via the instructing means, updates the prepaid balance and prevents the removal of the storage medium by operating the removal preventing means of the mounting mechanism until the updating of the prepaid balance is completed.

12. An image handling device comprising:
a mounting mechanism that mounts a storage medium on which image data is recorded and that has a prepay function;
an instructing means by which the user places an order for printing regarding the images recorded on the storage medium; and
a controller that inputs the image data recorded on the storage medium, calculates the fee for the printing ordered via the instructing means, updates the prepaid balance and nullifies the printing order if the storage medium is removed from the mounting mechanism before the prepaid balance is updated.

13. An image handling device comprising:
a mounting mechanism that mounts a storage medium on which image data is recorded and that has a prepay function;
an instructing means by which the user places an order for printing regarding the images recorded on the storage medium;
a money receiving means that receives money; and
a controller that reads the image data recorded on the storage medium, processes the receipt of money via the money receiving means, calculates the fee for the printing ordered via the instructing means, updates the prepaid balance and settles the printing fee by combining together the prepaid balance in the storage medium and the cash added using the money receiving means.

14. An image handling device comprising:
a mounting mechanism that mounts a storage medium on which image data is recorded and that has a prepay function;
an instructing means by which the user places an order for printing regarding the images recorded on the storage medium;
a money receiving means that receives money; and
a controller that inputs the image data recorded on the storage medium, processes the receipt of money via the money receiving means, calculates the fee for the printing ordered via the instructing means, updates the prepaid balance and updates the prepaid balance of the storage medium by combining together the prepaid balance in the storage medium and the cash added using the money receiving means.

15. An image handling device comprising:
a mounting mechanism that mounts a storage medium on which image data is recorded and that has a prepay function;
an instructing means by which the user places an order for printing regarding the images recorded on the storage medium; and
a control means that reads the image data recorded on the storage medium, calculates the fee for the printing ordered via the instructing means, updates the prepaid balance and accesses the prepayment information in the storage medium and outputs the information using a display means or a printing means.

16. An image handling device comprising:
a mounting mechanism that mounts a storage medium on which image data is recorded and that has a prepay function;
an instructing means by which the user places an order for printing regarding the images recorded on the storage medium; and
a control means that reads the image data recorded on the storage medium, calculates the fee for the printing ordered via the instructing means, updates the prepaid balance and calculates the printing fee in accordance with the printing history.

17. A printing fee recording method in an image output system comprising a mounting mechanism that mounts a storage medium on which image data is recorded and that has a prepay function, an instructing means by which the user places an order for printing regarding the images recorded on the storage medium, and a printing means that prints the images recorded on the storage medium, the method comprising the steps of:
reading the image data from the storage medium; and
recording the printing history on the storage medium, calculating a fee for the ordered printing based on the printing history, and recording the prepaid balance on the storage medium is updated according to the user orders printing of the images recorded on the storage medium.

18. The computer-readable storage medium which stores a program comprising the step of:
reading image data from the storage medium in which the image data is recorded and which has a prepay function;
receiving a printing order from the user for the images recorded on the storage medium;
printing the images by the printing means in accordance with the printing order; and
updating the prepaid balance in the prepayment information in the storage medium after the printing order is executed.
